(19) United States
(12) Patent Application Publication
(10) Pub. No.: US 2009/0097622 A1
(43) Pub. Date: Apr. 16, 2009

(54) Networking Character Information

(75) Inventor: Troed Nils Rickard Sangberg, Malmo (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/874,239

(22) Filed: Oct. 18, 2007

Related U.S. Application Data
(60) Provisional application No. 60/979,987, filed on Oct. 15, 2007.

(51) Int. Cl. H04M 11/00

(52) U.S. Cl. 379/93.23

(57) ABSTRACT

A method and apparatus for a receiving party to receive character information about a calling party from a designated network of individuals linked with the receiving party is described herein. A server operatively connected to a communication system stores character information comprising factual or opinion character information about one or more individuals in the communication system. Responsive to a triggering event, the receiving party's communication device sends a request to the server for character information about a calling party. The server identifies character information corresponding to the calling party and provided by one or more individuals linked with the receiving party by searching the server and/or obtaining real-time character information. The server sends the identified character information to the receiving party's communication device.

### RELATED APPLICATION

This application claims the benefit of U.S. Provisional Patent Application 60/979,987, filed Oct. 15, 2007, which is incorporated herein by reference.

### BACKGROUND

The present invention relates generally to providing information about calling and/or receiving parties in a two-way communication, and more particularly to providing character information about a calling party to a receiving party.

Mobile terminals have evolved over the years to provide not only voice services, but also to provide a wide array of data services. Users of mobile terminals are now able to browse web pages, compose and read email messages, chat with their friends and acquaintances, download music and/or video files from Internet servers, and send and receive digital photographs. Many mobile terminals are capable of concurrent voice and data communications. With concurrent voice and data, a user may, for example, send a photograph to a friend while engaged in a telephone conversation with that friend. Thus, the ability to engage in concurrent voice and data communications provides an opportunity to create a richer and more satisfying experience for the user.

When a user receives an incoming call alert, particularly from an unknown calling party, the user may want to obtain certain information about the calling party before answering or concluding the call. For example, the user may want to know if their friends know the calling party and/or what they think of the calling party. Currently, there is no convenient way to make such information electronically available to the user when the user receives a call alert or is engaged in a call.

### SUMMARY

The present invention provides a method and apparatus for a receiving party to receive character information about a calling party from a designated network of individuals linked with the receiving party. Responsive to a triggering event, the receiving party's communication device requests character information about a calling party. The communication system sends character information corresponding to the calling party and provided by one or more designated individuals linked with the receiving party, e.g., individuals in the receiving party's social network, to the receiving party's communication device. The character information comprises opinion and/or factual character information provided by individuals linked with the receiving party. The character information may be stored in a server and/or may be obtained in real-time. The communication device may output the received character information to the receiving party via an output device, e.g., a display. Alternatively, the communication device may store the received character information so that the receiving party may review the character information at a later time.

### BRIEF DESCRIPTION OF THE DRAWINGS

FIG. 1 shows a block diagram of a communication system.

FIG. 2 shows a block diagram of an exemplary communication device according to one embodiment of the present invention.

FIG. 3 shows a process diagram for requesting and receiving character information according to one embodiment of the present invention.

### DETAILED DESCRIPTION

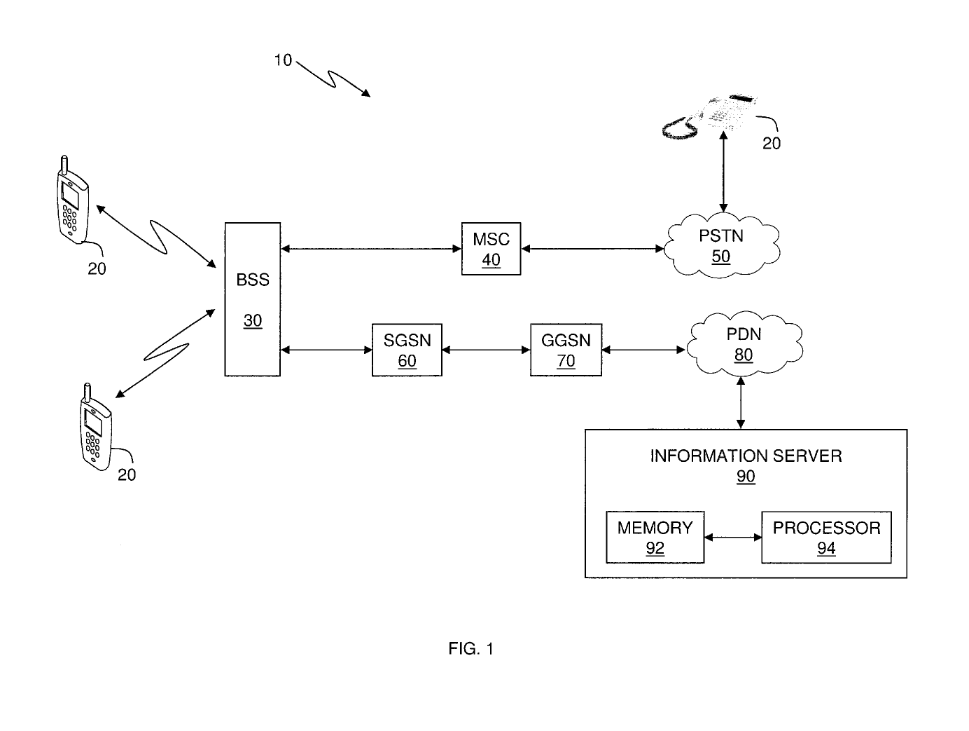

The present invention provides requested character information about a calling party to a communication device of a receiving party in a communication system. FIG. 1 shows an exemplary communication system 10. While FIG. 1 generally shows a communication system based on the Global System for Mobile communications (GSM) and the General Packet Radio Service (GPRS) protocols, it will be appreciated that the embodiments described below apply to any wireless or landline communication system, and to any access technology. Exemplary access technologies include, but are not limited to, GSM, WCDMA, WiFi, WiMAX, OFDM, and LTE.

Communication system 10 implements circuit switched services using a Base Station Subsystem (BSS) 30, a Mobile Switching Center 40, and a Public Switched Telecommunication Network (PSTN) 50. BSS 30 handles traffic and control signaling between one or more mobile communication devices 20 and the MSC 40. The MSC 40 carries out switching functions and manages the connections between the BSS 30 and the PSTN 50. The PSTN 50 comprises a network of circuit-switched telephone networks that connect one or more landline communication devices 20 with MSC 40.

Communication system 10 also implements packet switched services using the BSS 30, a Serving GPRS Support Node (SGSN) 60, a Gateway GPRS Support Node (GGSN) 70, and a Packet Data Network (PDN) 80. The SGSN 60 is responsible for delivering data packets to and from mobile communication devices 20 via the BSS 30. The GGSN 70 interfaces the SGSN 60 with the PDN 80. More particularly, the GGSN 70 readdresses data packets provided by the PDN 80, and forwards the readdressed data packets to the SGSN 60. Further, the GGSN 70 converts data packets from the SGSN 60 into an appropriate Packet Data Protocol (PDP) format, and forwards the converted data packets to the PDN 80.

The PDN 80 interconnects multiple external data networks, e.g., Internet and Intranet networks. According to the present invention, PDN 80 also connects to an information server 90 comprising a memory 92 and a processor 94. Memory 92 stores character information about users in the communication system 10 that is provided by other users in the communication system 10. The character information may comprise information in any format, e.g., graphical, text, and/or audio formats. Responsive to a request, server 90 retrieves selected character information according to process instructions provided by processor 94, as discussed further below. The server 90 may send the retrieved character information to the requesting device 10 using any known means, e.g., in a text message, a multimedia message, over a packet switched data channel over the Internet, etc.

The stored character information may comprise opinion character information, e.g., Johnny is nice, or may comprise factual character information, e.g., Chris has been employed for over 10 years. Memory 92 cross-references the stored character information with both the subject of the character information and with the user that provided the character information to the server 90 using, for example, identification numbers associated with the communication devices of the subject user and the providing user. Table 1 shows exemplary character information stored in memory 92. It will be appreciated that server 90 updates memory 92 each time the server 90 receives character information from a user in the communication system 10. Further, it will be appreciated that users may provide character information about other users at any time using any known means, e.g., text messages, email, etc.

TABLE 1

| | | Subject of Character Information | | | | |
|---|---|---|---|---|---|---|
| | | Nikki | Kary | Max | Shane | Rich |
| Character | Individual #1 | Spoiled brat. | Very funny | Jealous-type | Employed | Creep |
| Info | Individual #2 | Friendly | Generous | Wealthy | | |
| Provider | Individual #3 | Smart | | | Cute | Arrogant |

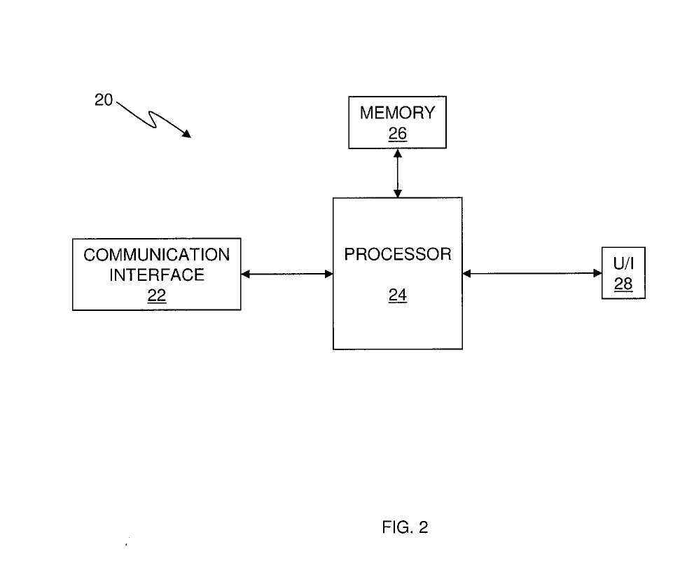

The communication system 10 facilitates communications between the server 90 and one or more communication devices 20. FIG. 2 shows an exemplary block diagram of a communication device 20 comprising a communication interface 22, a processor 24, a memory 26, and a user interface 28. Communication interface 22 may comprise a wireless interface that wirelessly communicates with BSS 30, e.g., a wireless transceiver and antenna. Alternatively or additionally, communication interface 22 may comprise a landline interface that connects with PSTN 50 using a wire, cable, or other fixed interface. Processor 24 controls the communication device 20 according to instructions stored in memory 26. The user interface 28 interfaces the communication device 20 with the user. While not explicitly shown, user interface 28 may comprise a display, keypad, speaker, and microphone.

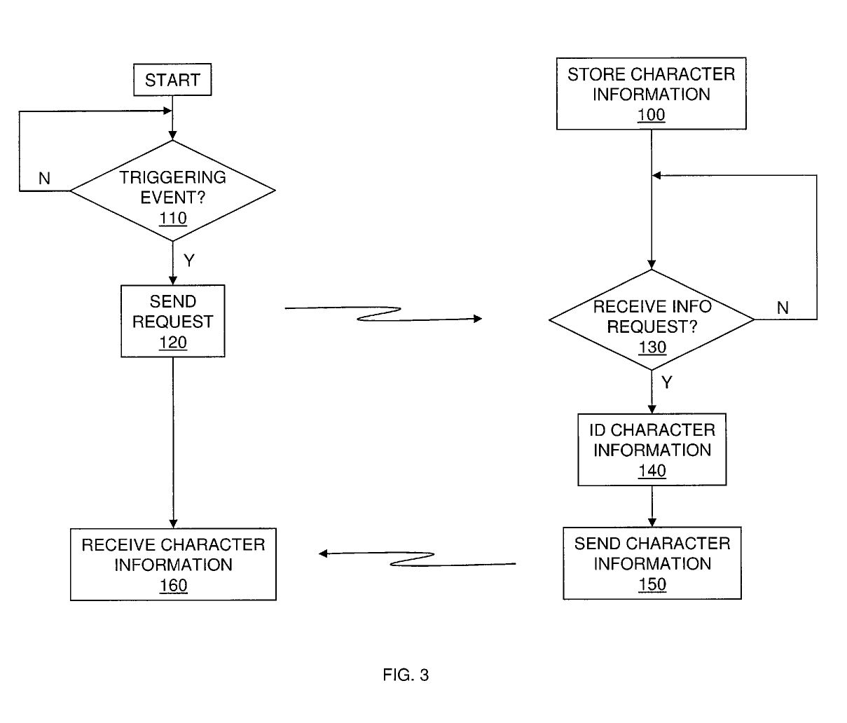

According to the present invention, the processor 24 in a receiving party's communication device 20 requests character information about a calling party from the server 90 responsive to a triggering event. FIG. 3 shows an exemplary process according to one embodiment of the present invention. The memory 92 in server 90 stores character information corresponding to users of communication devices throughout the communication system 10 (block 100). When a communication device 20 receives a triggering event (block 110), the processor 24 in the communication device 20 sends a request for character information about the calling party to the server 90 (block 120). The request identifies the calling party and the receiving party. When the server 90 receives the request (block 130), the processor 94 in the server 90 searches through the character information stored in memory 92 to identify the character information corresponding to the calling party and provided to the server 90 by individuals linked with the receiving party (block 140). The individuals linked with the receiving party and used by the server 90 to identify the desired character information may comprise individuals in the receiving party's social, familial, and/or professional network. The server 90 may use a predetermined list of individuals provided by the receiving party and stored in memory 92. Alternatively, the server 90 may use a list of individuals provided with the request. In still another example, the server 90 may define the individuals as those in the receiving party's address book or those individuals that have recently called the receiving party. In any event, the processor 94 sends the identified character information to the communication device 20 of the receiving party (block 150). After receiving the character information (block 160), the communication device 20 may either store the received character information in memory 26 or may output the received character information to one or more elements of the user interface 28, such as the display.

The triggering event that triggers the above-described process may comprise any communication or user-initiated event. In one embodiment, the triggering event comprises an incoming call or message alert from a calling party unknown to the receiving party. In this case, the receiving party's communication device 20 may determine that the alert is a triggering event because the calling party's identification is not stored in the memory 26 of the communication device 20. In another embodiment, the triggering event comprises user input, such as user activation of a key on the keypad. In still another embodiment, the triggering event comprises an incoming call or message alert from a calling party that infrequently calls the receiving party or that has not recently called the receiving party, e.g., has not called in over 6 months or some other user-defined time period. It will be appreciated that the above examples are illustrative and do not limit the triggering events applicable to the present invention.

Consider the following non-limiting example. Jane receives an incoming call alert on her mobile phone. Because this is the first time the calling party has called Jane on her mobile phone, the mobile phone sends a request for character information to the server 90. After searching through the memory 92, the processor 94 initially discovers twenty character information listings associated with the calling party's identification number. After filtering the initial twenty listings based on a predetermined list of individuals linked with Jane, the processor 94 identifies character information about the calling party provided to the server 90 by Jane's sister, Jane's boss, and Jane's best friend. The processor 94 sends the identified character information to Jane's mobile phone. Jane's mobile phone outputs the received character information to which provide Jane with character information about the calling party. Jane may choose to either answer or ignore the call based on the received character information.

The present invention may also or alternatively provide real-time character information from individuals linked with the receiving party. In one embodiment, the server 90 may solicit real-time character information about a calling party from one or more individuals linked with the receiving party using any known communication means, e.g., text messaging, wireless calls, email, etc. For example, the server 90 may solicit real-time character information from Jane's sister. The server 90 forwards the received real-time character information to the communication device 20 of the receiving party in addition to or alternatively to the character information discovered in the server's memory 92. For this embodiment, the request may further identify whether the receiving party prefers pre-stored character information, real-time character information, or both. It will be appreciated that the communication system 10 may alternatively implement a peer-to-peer approach to solicit real-time character information about the calling party by forwarding the request directly to the communication device of one or more of the individuals linked with the receiving party. As such, it will be appreciated that server 90 is not required to provide real-time character information about a calling party.

The above-described embodiment provides the benefits of social networking, even when the individuals linked with the receiving party are not with the receiving party. The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of providing character information about a calling party to a communication device of receiving party in a communication system, the method comprising:
receiving a request from the receiving party for character information about the calling party;
identifying character information about the calling party provided by one or more individuals linked with the receiving party responsive to the request; and
sending the identified character information to the communication device of the receiving party.

2. The method of claim 1 further comprising storing character information associated with one or more individuals in the communication system on a server operatively connected to the communication system, wherein identifying the character information comprises searching the server to identify stored character information corresponding to the calling party provided to the server by the one or more individuals linked with the receiving party.

3. The method of claim 1 wherein identifying the character information comprises:
sending a second request to one or more of the individuals linked with the receiving party; and
receiving real-time character information about the calling party from one or more of the individuals responsive to the second request.

4. The method of claim 1 wherein the one or more individuals linked with the receiving party comprise one or more individuals in at least one of a social network, a professional network, and a family network of the receiving party.

5. The method of claim 1 wherein the request includes a calling party identifier and a receiving party identifier, and wherein identifying character information comprises identifying character information corresponding to the calling party identifier provided by the one or more individuals linked with the receiving party identifier.

6. A server operatively connected to a communication system and configured to provide character information about a calling party to a communication device of a receiving party, the server comprising a processor configured to:
receive a request for character information about the calling party from the communication device;
identify character information about the calling party provided by one or more individuals linked with the receiving party responsive to the request; and
send the identified character information to the communication device.

7. The server of claim 6 further comprising memory to store character information based on a subject of the character information and a provider of the character information, wherein the processor identifies the character information by searching the memory to identify the character information corresponding to the calling party provided to the server by the one or more individuals linked with the receiving party.

8. The server of claim 6 wherein the processor identifies the character information by:
sending a second request to one or more of the individuals linked with the receiving party; and
receiving real-time character information about the calling party from one or more of the individuals linked with the receiving party responsive to the second request.

9. The server of claim 6 wherein the one or more individuals linked with the receiving party comprise one or more individuals in at least one of a social network, a professional network, and a family network of the receiving party.

10. The server of claim 6 wherein the request includes calling party identifier and a receiving party identifier, and wherein the processor identifies the character information about the calling party by identifying character information corresponding to the calling party identifier provided by the one or more individuals linked with the receiving party identifier.

11. A method of obtaining character information about a calling party at a communication device of a receiving party in a communication system, the method comprising:
receiving a triggering event associated with the calling party at the communication device;
responsive to the triggering event, sending a request for character information about the calling party to the communication system; and
receiving character information about the calling party responsive to the request, wherein said received character information comprises character information provided to the communication system by one or more individuals linked with the receiving party.

12. The method of claim 11 wherein the received character information comprises character information stored on a server by the one or more individuals linked with the receiving party.

13. The method of claim 11 wherein the received character information comprises real-time character information provided by the one or more individuals linked with the receiving party.

14. The method of claim 11 wherein the one or more individuals linked with the receiving party comprise one or more individuals in at least one of a social network, a professional network, and a family network of the receiving party.

15. The method of claim 11 wherein receiving a triggering event comprises receiving an incoming communication triggering event associated with an unknown calling party.

16. The method of claim 11 wherein receiving a triggering event comprises receiving user input.

17. A communication device in a communication system, the communication device comprising a processor configured to:
receive a triggering event associated with a calling party;
responsive to the triggering event, send a request for character information about the calling party to the communication system; and
receive character information about the calling party responsive to the request, wherein said received character information comprises character information provided by one or more individuals linked with the receiving party.

18. The communication device of claim 17 wherein the received character information comprises character information stored on a server by the one or more individuals linked with the receiving party.

19. The communication device of claim 17 wherein the received character information comprises real-time character information provided to the communication system by the one or more individuals linked with the receiving party.

20. The communication device of claim 17 wherein the one or more individuals linked with the receiving party comprise one or more individuals in at least one of a social network, a professional network, and a family network of the receiving party.

21. The communication device of claim 17 wherein the triggering event comprises an incoming communication triggering event associated with an unknown calling party.

22. The communication device of claim 17 wherein the triggering event comprises user input.

23. The communication device of claim 17 further comprising an output device to output the received character information to the receiving party.
